(19) United States
(12) Patent Application Publication
(10) Pub. No.: US 2016/0071135 A1
(43) Pub. Date: Mar. 10, 2016

(54) METHOD FOR OBTAINING BUSINESS INTELLIGENCE INFORMATION FROM A LARGE DATASET

(71) Applicant: SITECORE CORPORATION A/S, KOBENHAVN V (DK)

(72) Inventors: Michael SEIFERT, Kobenhavn V (DK); Martin OTTOSEN, Kobenhavn V (DK); Morten Kruse SØNDERGAARD, Kobenhavn V (DK); Alex SHYBA, Kobenhavn V (DK)

(73) Assignee: SITECORE CORPORATION A/S, KOBENHAVN V (DK)

(21) Appl. No.: 14/840,959

(22) Filed: Aug. 31, 2015

Related U.S. Application Data
(60) Provisional application No. 62/047,405, filed on Sep. 8, 2014.

(30) Foreign Application Priority Data
Dec. 19, 2014 (DK) 201470811

(51) Int. Cl. G06Q 30/02; H04L 29/08; G06F 17/30

(52) U.S. Cl. CPC G06Q 30/0204; G06F 17/30563; H04L 67/22; G06F 17/30876

(57) ABSTRACT

Behavioural data relating to online interactions is collected and stored in the form of a raw dataset. A data filter created on the basis of defined characteristics of interest is applied to the raw dataset, thereby obtaining a subset of data. Business intelligence analysis is performed on the data of the subset of data, and a business intelligence report is generated, in accordance with the defined characteristics of interest.

### FIELD OF THE INVENTION

The present invention relates to a method for obtaining business intelligence information relating to online interactions, e.g. online interactions between a company and customers of the company and/or between a website and visitors to the website. The method of the invention provides fast and precise extraction of relevant information, even from large datasets.

### BACKGROUND OF THE INVENTION

Business intelligence (BI) is often used to analyse data collected during various online interactions, such as visits to a website. The analysis may be performed on SQL style data organised in a database of a very rigid structure. An end user can interactively query the data of the database, and the database technology will reply back with relatively fast responses to the queries. This process consumes a considerable amount of computer processing unit (CPU, I/O, memory, and/or bandwidth) capacity, in particular if the database contains a considerable amount of data. Furthermore, the process is relatively inflexible. Data facets which it is desired to analyse must be defined and associated with the database, and once the data facets are defined, it is not easy to redefine them or add further data facets to the database.

In order to reduce the amount of required CPU capacity, the analysis may be performed on a reduced dataset, in which some of the data records are simply removed from the dataset before the analysis is performed. For instance, the analysis may be performed on a representative sample of the dataset, and the result of the analysis may be scaled up to the size of the entire dataset. However, this can result in high inaccuracy in the case that the part of the analysed data which is actually relevant with respect to the performed analysis turns out to be relatively small.

US 2014/0012800 A1 discloses an apparatus and a method for processing big data. A setting unit sets data collection and analytic levels and a result screen for each of a plurality of tenants. A unified information access unit collects data based on the settings of the setting unit, and analyses the collected data. A customized online service is provided for each of a plurality of tenants.

US 2006/0085469 A1 discloses a system and a method for automated rule based content mining, analysis and implementation of consequences to input data. Analysis is performed on large sets of data, based on defined rules, to extract useful data therefrom.

### DESCRIPTION OF THE INVENTION

It is an object of embodiments of the invention to provide a method for obtaining business intelligence information relating to online interactions, which reduces the amount of required computer processing unit (CPU, etc.) capacity for performing the analysis.

It is a further object of embodiments of the invention to provide a method for obtaining business intelligence information relating to online interactions, in which the risk of excluding relevant data in the analysis is minimised.

It is an even further object of embodiments of the invention to provide a method for obtaining business intelligence information relating to online interactions, which allows additional data facets to be added into large datasets, while allowing new analysis to be easily performed.

The invention provides a method for obtaining business intelligence information relating to online interactions, the method comprising the steps of:
collecting, by means of a computer device, behavioural data relating to online interactions, originating from a plurality of online interactions, and storing the collected behavioural data in the form of a raw dataset,
defining one or more characteristics of interest of the behavioural data,
creating a data filter, based on the defined characteristics of interest, said data filter defining information of the collected behavioural data being relevant with respect to the defined characteristics of interest,
applying the data filter to the raw dataset, thereby obtaining a subset of the data of the raw dataset, said subset containing behavioural data being relevant with respect to the defined characteristics of interest,
performing business intelligence analysis on the data of the subset of data, and
generating a business intelligence report based on the business intelligence analysis, and in accordance with the defined characteristics of interest.

The invention provides a method for obtaining business intelligence information relating to online interactions. In the present context the term ‘business intelligence information’ should be interpreted to mean information extracted from a dataset collected with the purpose of transforming raw data into meaningful and useful information for business analysis purposes.

In the present context the term ‘online interactions’ should be interpreted to mean any suitable interaction taking place online, such as a visitor visiting a website, social media, etc., e-mail communication, responses to online advertisements, etc.

Initially behavioural data relating to online interactions is collected by means of a computer. The collected behavioural data originates from a plurality of online interactions, i.e. a large amount of data, e.g. with a great variety, is collected. The collected behavioural data is stored in the form of a raw dataset. Accordingly, the raw dataset is a relatively large dataset, where little or none of the collected behavioural data is removed from the dataset. Furthermore, the behavioural data of the raw dataset is statistically significant, i.e. the raw dataset contains a sufficient amount of data to allow meaningful statistical analysis to be performed on the data of the raw dataset. Furthermore, the raw data is not stored in a rigid SQL structure but in a more loosely defined manner such as with e.g. NO SQL, XML, etc.

Furthermore, the method may include collecting behavioural data relating to offline interactions, and storing the collected behavioural data as part of the raw dataset.

Next one or more characteristics of interest of the behavioural data is/are defined. The characteristics of interest are characteristics of the behavioural data which relate to business intelligence aspects which it is desired to investigate. The characteristics may, e.g., be in the form of dimensions or facets of the data.

Then a data filter is created, based on the defined characteristics of interest. The data filter defines information of the collected behavioural data which is relevant with respect to the defined characteristics of interest. Thus, the data filter is designed to identify data records of the raw dataset which contain information which is relevant with respect to the business intelligence aspect which it is desired to investigate. Accordingly, the data filter can be used for extracting the data records which are truly relevant, while ignoring the data records which appear to be of less relevance, thereby allowing analysis to be performed on the truly relevant data records only. However, no data records are removed from the raw dataset, i.e. the raw dataset remains intact, thereby preserving the possibility of defining new and completely different characteristics of interest at a later point in time, and to extract the data records being relevant with respect to the new characteristics of interest from the original and complete raw dataset.

Accordingly, the created data filter is then applied to the raw dataset. Thereby a subset of the raw dataset is obtained. Since the subset of data is obtained by applying the data filter described above to the raw dataset, the data comprised in the subset contain behavioural data which is relevant with respect to the defined characteristics of interest, and thereby represents the part of the raw dataset which is actually relevant with respect to business intelligence aspects which it is desired to investigate. On the other hand, the part of the raw dataset which does not form part of the subset of data may be considered as having no or only very limited relevance with respect to the business intelligence aspects which it is desired to investigate.

Business intelligence analysis is then performed on the data of the subset of data. Since the subset of data is obtained as described above, the business intelligence analysis is performed on the part of the raw dataset which contains information which is actually relevant with respect to the business intelligence aspects which it is desired to investigate, while data of less or no relevance is ignored. Accordingly, the analysis only involves a part of the raw dataset, thereby reducing the required CPU capacity and possibly decreasing the response time. Furthermore, the selection of the subset of data is performed in an ‘intelligent’ manner, which takes into account the business intelligence aspects which it is desired to investigate.

Thereby the risk of excluding relevant data from the analysis is minimised, and an accurate result of the analysis can be expected.

Finally, a business intelligence report is generated, based on the business intelligence analysis, and in accordance with the defined characteristics of interest. The business intelligence report may, e.g., be or comprise a graphical presentation, such as a graph, a pie chart, a bar chart, etc. The business intelligence report may, e.g., include several business analyses, which in combination provide a more complete analysis of the defined characteristics of interest.

It may be attempted to group the raw data in accordance with the persons behind the data, i.e. the human beings performing the online interactions, and thereby giving rise to the behavioural data. Alternatively or additionally, the raw data may be grouped in accordance with the devices used by the persons behind the data. Furthermore, a data record originating from a given person and a data record originating from a given device may be merged in the case that it is discovered that both of these data records in fact originate from the same human being.

One example of an implementation of the method described above could be as follows. An owner of a website wishes to investigate the geographical distribution of visitors to the website. He is only interested in visitors from Europe. In this case the online interactions include visits to the website performed by various visitors. The raw dataset contains behavioural data collected during a plurality of such visits. The raw dataset may comprise further kinds of online interactions between the website owner's corporation and visitors or potential visitors to the website, for instance e-mail correspondence, interactions via social media, responses to online advertisements, etc.

The website owner defines a characteristic of interest in the form of ‘Geographical origin; European countries’. A data filter is then created which is capable of distinguishing data records of a raw dataset based on the geographical origin of the visitors, and the data filter specifies that only data originating from visits performed by visitors located in a European country is relevant, i.e. data originating from visitors located in any non-European country should be ignored.

The created data filter is then applied to the raw dataset. Thereby a subset of data is extracted (e.g. streamed) from the raw dataset, and the subset of data only contains data originating from visits performed by visitors located in a European country. This is still a potentially large dataset. Thus, the subset of data contains the data which is relevant with respect to the intended investigation, while the data which is not relevant in this respect is excluded from the subset of data. The raw dataset remains intact, i.e. the subset of data is merely extracted (e.g. streamed) from the raw dataset or identified as relevant with respect to the desired analysis.

The subset of data may further be aggregated and reduced. This may, e.g., include grouping the data with respect to time units, such as grouping the visits by the hour, by the day, etc. Thereby the data filter is not keeping all of the raw data in the in reduced dataset, but only the metrics, such as the number of visits or other online actions, number of visits per time unit, average number of visits per time unit, etc., are kept. This will reduce the size of the dataset dramatically, e.g. from gigabytes to kilobytes.

Business intelligence analysis is then performed on the subset of data, and a report is generated showing the result of the analysis. The report may, e.g., be or include a graph or a chart illustrating the distribution of visitors among various European countries.

Note that in this case the “business intelligence” may be limited, since the stored data essentially represents the resulting graph that a person wants to see. Thus, in this case, minimal CPU is used to extract the data.

Thus, the business intelligence analysis is only performed on a part of the vast amount of data comprised in the raw dataset, and therefore a reduced amount of CPU capacity is required. On the other hand, all relevant data records are included in the analysis, and the excluded data records are all irrelevant, since they originate from visits performed by visitors located outside Europe. This ensures that the analysis result is accurate.

Apart from the geographical information described above, the raw dataset may comprise data regarding which kind of device each of the visitors used. Furthermore, the raw dataset may be enriched with data from a CRM system, providing information regarding which of the persons are already existing customers. It may be desirable to investigate how the kind of device used affects the behaviour of the persons. To this end a data filter is created which defines that only data originating from persons using a smartphone is relevant, and this data filter is applied to the country report described above. This allows an analyst to readily see the distribution of smartphone users among the various countries. Finally another data filter may be created defining persons who are existing customers, and yet another report is provided which relates to existing customers using a smartphone and located in various countries.

To reduce CPU (IO, network, etc) it is possible to read a record from the raw dataset once, then apply all the filters, and for each matching filter, reduce the data as described above. Thus essentially producing one final graph or table per filter. This will save a lot of CPU resources.

In another example of an implementation of the method according to the invention, it may be desirable to derive information regarding to online interactions originating from people located in large cities. Since the number of cities worldwide is very large, the cities may be ranked, e.g. with respect to size, number of online interactions or any other suitable criteria. The 1,000 cities having the highest ranking may be investigated individually, while the remaining cities may be investigated in one go as ‘other cities’. This will allow thorough analysis of the data records originating from the top 1,000 cities.

However, if an analyst is actually interested in data records originating from people located in Danish cities, this reduced dataset is not very useful, since the cities in Denmark are relatively small on a worldwide scale, and therefore none or only a few Danish cities will most likely be present among the top 1,000 cities. Then the invention allows a data filter to be created which results in a subset of data which contains data originating from online interactions performed by persons located in Denmark. The ranking described above is maintained, but now the top 1,000 Danish cities are listed, and a much more useful report can be generated for that analyst.

The method may further comprise the step of storing the result of the business intelligence analysis in the form of a transformed and reduced dataset, separate from the raw dataset. According to this embodiment, the transformed and reduced dataset includes the behavioural data which was identified by means of the data filter, i.e. the data which was included in the subset of data. The transformed and reduced dataset further reflects the performed business intelligence analysis. Furthermore, the raw dataset remains intact, i.e. the transformed and reduced dataset is stored separate from and in addition to the original raw dataset.

For instance, the step of performing business intelligence analysis may comprise aggregating the filtered data and storing the aggregated data in a transformed and reduced dataset, separate from the raw dataset, and in a form which is more suitable for reporting. Thereby the business intelligence report can readily be generated from the transformed and reduced dataset.

The stored transformed and reduced dataset may be used for the purpose of further analysis or data mining. Referring to the example discussed above, the website owner may, e.g., further wish to investigate specific behaviour of the visitors during their visits, for instance whether or not a specific form is filled in and submitted, or whether or not the visits result in a purchase of products. If the website owner is still only interested in the visitors which are located in European countries, then the created data filter is still applicable in the sense that it extracts the data which originates from visits of visitors located in European countries, while ignoring data originating from any other visit. Therefore the further analysis may advantageously be performed on the previously stored transformed and reduced dataset.

The step of defining one or more characteristics of interest may comprise defining information to be presented in the business intelligence report. According to this embodiment, the data filter is capable of identifying data records of the raw dataset which include or relate to information which it is desired to receive via the business intelligence report. Such information could, e.g., include information regarding geographical location of individuals performing online interactions, specific behavioural information, such as specific actions performed during online interactions, responses to specific types of online advertisements, etc.

Alternatively or additionally, the step of defining one or more characteristics of interest may comprise defining one or more graphs to be presented in the business intelligence report. According to this embodiment, the data filter is capable of identifying data records of the raw dataset which contain information which is relevant with respect to generating the desired graph(s).

The step of creating a data filter may comprise creating a data filter which selects a subgroup of online interactions, and the step of applying the data filter to the raw dataset may comprise including at least part of the collected data originating from the online interactions of the subgroup of online interactions in the subset of data. According to this embodiment, the defined characteristics of interest are of a kind which relates to the online interactions. For instance, the characteristics of interest may, in this case, include geographical origin of the individuals performing the online interactions, online platforms used by the individuals performing the online interactions, campaigns giving rise to the online interactions, etc. Thereby only data originating from online interactions matching the defined characteristics will be included in the subset of data.

Alternatively or additionally, the step of creating a data filter may comprise creating a data filter which defines types of data collected during the online interactions, and the step of applying the data filter to the raw dataset may comprise including at least part the collected data originating from online interactions comprising the defined types of data in the subset of data. According to this embodiment, the defined characteristics of interest are of a kind which relates to the data being collected during the online interactions, rather than to the online interactions as such. For instance, the characteristics of interest may, in this case, include specific behavioural patterns, such as specific actions performed during the online interactions, specific content viewed or downloaded during the online interactions, etc. The subset of data may include only the data which relates to the defined information. As an alternative, the subset of data may include further data, which has been collected during the online interactions, which include the defined types of data, such as all data collected during the identified online interactions.

Alternatively or additionally, the step of creating a data filter may comprise creating a data filter which defines specific criteria for data collected during the online interactions, and the step of applying the data filter to the raw dataset may comprise including at least part of the collected data originating from online interactions comprising data fulfilling the specific criteria in the subset of data. The specific criteria may, e.g., include online interactions performed within a specified time interval, online interaction in which a poll is responded to in a specific manner, etc. Alternatively or additionally, data filters may be defined based on data from a customer relation management (CRM) system, e.g. visits from visitors that have been identified in the CRM data, such as visitors who are already identified in the CRM system. In this scenario, data from CRM may be applied as data filter on the raw data set.

The step of generating a business intelligence report may comprise generating one or more graphs, and displaying the graph(s). Thereby a quick and simple overview of the result of the business intelligence analysis is provided for a user requesting the analysis. The graph(s) may include traditional graph(s), various kinds of charts, such as pie charts or bar charts, and/or any other suitable kind of graphical representation.

The method may further comprise the steps of:
allowing an additional online interaction to take place,
collecting, by means of a computer device, behavioural data relating to the additional online interaction, and including the collected behavioural data in the raw dataset,
during the step of collecting behavioural data, applying the data filter to the behavioural data being collected, and
including at least part of the collected behavioural data in the subset of data to the extent that the collected data fulfils criteria defined by the data filter.

According to this embodiment, further online interactions are monitored after the original raw dataset has been generated, and behavioural data is collected for each of the further online interactions in the same manner as the data included in the original raw dataset was collected. The collected data is included in the raw dataset, i.e. the raw dataset is continuously increased and updated as further online interactions are performed.

Furthermore, while behavioural data relating to the further online interactions is being collected, the data filter is applied to the behavioural data. If it turns out that the collected behavioural data for a given online interaction matches the criteria defined by the data filter, then the collected behavioural data relating to that online interaction, or at least a relevant part of the collected behavioural data, is included in the subset of data. Thereby the collected behavioural data relating to the further online interaction is taken into account during the business intelligence analysis.

Thus, according to this embodiment, an ‘aggregation layer’ is added which filters and analyses the collected behavioural data as it is collected. This ensures very low response times, because the analysis result is simply updated to include the newly collected data, and analysis of the entire available material is not required.

The method may further comprise the steps of:
defining one or more new characteristics of interest of the behavioural data,
creating a new data filter, based on the new defined characteristics of interest, said new data filter defining information of the collected behavioural data being relevant with respect to the new defined characteristics of interest,
applying the new data filter to the raw dataset, thereby obtaining a new subset of the data of the raw dataset, said new subset containing behavioural data being relevant with respect to the new defined characteristics of interest,
performing business intelligence analysis on the data of the new subset of data, and
generating a business intelligence report based on the business intelligence analysis, and in accordance with the new defined characteristics of interest.

It may be desired to investigate a business intelligence aspect which is completely different from the business intelligence aspect which was originally investigated. Since the raw dataset is stored and maintained intact, as described above, it is possible to obtain this, simply by defining one or more new characteristics of interest of the behavioural data, where the new characteristics of interest relate to and/or reflect the new business intelligence aspect. Then the process described above is simply repeated, but on the basis of the new characteristics of interest. The new business intelligence report resulting from this process will be based on collected data which is relevant with respect to the new characteristics of interest. Previously generated business intelligence reports may be maintained, even though a new business intelligence report is generated, e.g. with the purpose of allowing the reports to be compared.

Alternatively or additionally, the method may further comprise the steps of:
defining one or more additional characteristics of interest of the behavioural data,
adjusting the data filter, based on the additional characteristics of interest, said adjusted data filter defining information of the collected behavioural data being relevant with respect to the additional characteristics of interest,
applying the adjusted data filter to the subset of the data of the raw dataset, thereby obtaining a reduced subset of data, said reduced subset containing behavioural data being relevant with respect to the additional characteristics of interest,
performing business intelligence analysis on the data of the reduced subset of data, and
generating a business intelligence report based on the business intelligence analysis, and further in accordance with the additional characteristics of interest.

According to this embodiment, the business intelligence analysis can be further refined. The subset of data which was originally obtained by applying the original data filter to the raw dataset is further reduced by applying the adjusted data filter to the subset of data. Thus, the data of the reduced subset of data is relevant with respect to the original characteristics of interest, as well as with respect to the additional characteristics of interest. Accordingly, a refined business intelligence report is obtained.

The online interactions may comprise one or more interactions selected from the group consisting of: visit to a website, visit to social media, visit to mobile app, receipt of an e-mail, sending of an e-mail, filling in a form, and response to an online advertisement. As an alternative, any other suitable kind of online interaction may be used.

The method may further comprise the step of including offline data to the raw dataset. According to this embodiment, the raw dataset is enriched with offline data and/or with data which has been collected via other channels. This provides a more complete dataset, and it is possible to combine information obtained from the online data with information obtained from the offline data to obtain a more complete picture of the business intelligence aspects which it is desired to investigate.

The offline data may, e.g., include data from customer relation management (CRM) systems, data from enterprise resource planning (ERP) systems, data from point of sale (POS) systems, data relating to revenue relating to individual customers, etc.

The method may further comprise the step of importing behavioural data from one or more external data sources, said external data sources containing behavioural data relating to one or more individuals performing online interactions. The external data sources may, e.g., be data sources described above, i.e., CRM, ERP or POS. Thereby the raw dataset is enriched with data originating from other systems. For instance, in the case that a person is already a customer, data may be added to existing data regarding this person each time he or she purchases a product. For instances, invoices and/or invoiced amount could be added.

The method may further comprise the step of aggregating the data of the subset of data further. As described above, this step may form part of the step of performing business intelligence analysis. The aggregated data may further be stored in a transformed and reduced dataset, separate from the raw dataset.

### BRIEF DESCRIPTION OF THE DRAWINGS

The invention will now be described in further detail with reference to the accompanying drawings, in which

FIG. 1 is a diagrammatic view of a system for performing a method according to an embodiment of the invention,

FIG. 2 is a flow chart illustrating a method according to a first embodiment of the invention,

FIG. 3 is a flow chart illustrating a method according to a second embodiment of the invention,

FIG. 4 is a schematic overview illustrating a method according to an embodiment of the invention,

FIG. 5 is a schematic overview illustrating a method according to an alternative embodiment of the invention,

FIGS. 6 and 7 are graphical representations of business intelligence reports generated by means of a method according to an embodiment of the invention,

FIG. 8 is a schematic overview illustrating a method according to another alternative embodiment of the invention, and

FIG. 9 is a graphical representation of a business intelligence report containing two different business intelligence analyses generated by means of a method according to an embodiment of the invention.

### DETAILED DESCRIPTION OF THE DRAWINGS

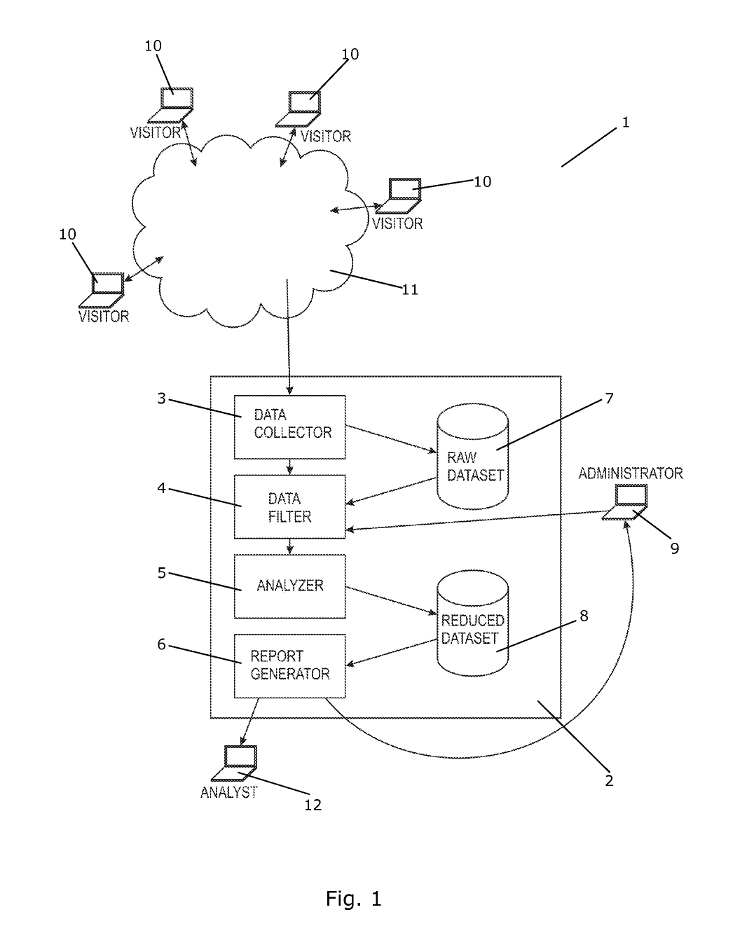

FIG. 1 is a diagrammatic view of a system 1 for performing a method for obtaining business intelligence information according to an embodiment of the invention.

The system 1 comprises a server 2 having a data collector 3, a data filter 4, an analyzer 5 and a report generator 6 residing thereon. The server 2 further has a raw dataset database 7 and a reduced dataset database 8 residing thereon.

The server 2 may be in the form of a single device. As an alternative, the server 2 may be in the form of two or more individual devices being interlinked in such a manner that they, to a user accessing the server 2, seem to act as a single device.

An administrator is capable of communicating with various components residing on the server 2, via an administrator device 9. This allows the administrator to define characteristics of interest of collected behavioural data, and to create a data filter, based on the defined characteristics of interest. In FIG. 1 the administrator device 9 is illustrated as a personal computer (PC), but it should be noted that the administrator device 9 could alternatively be a cell phone, a tablet, a television set, or any other suitable kind of device allowing the administrator to access the server 2.

A plurality of visitors each performs online interactions via respective visitor devices 10. In FIG. 1 the visitor devices are illustrated as personal computers (PC), but it should be noted that one or more of the visitor devices 10 could alternatively be a cell phone, a tablet, a television set, or any other suitable kind of device allowing the visitors to perform appropriate online interactions. The online interactions may be of various kinds, and may take place between the users and various entities, via a computer network 11. Examples of online interactions include, but are not limited to, visitors visiting a website, e-mail correspondence, responses to online advertisements, online interactions via social media, etc. It is noted that the term ‘visitor’ should be interpreted in a broad sense, covering individuals performing any relevant kind of online interaction. Thus, the term ‘visitor’ should not be limited to individuals performing visits, e.g. to a website.

During the online interactions, the data collector 3 collects behavioural data relating to the online interactions. The collected behavioural data is stored in the raw dataset database 7. Thus, the raw dataset database 7 contains all data collected during the performed online interactions.

When it is desired to obtain business intelligence information, the data filter 4 is applied to the raw dataset stored in the raw dataset database 7. The data filter 4 has previously been created, based on characteristics of interest of the behavioural data, which have been defined by the administrator. The characteristics of interest reflect business intelligence aspects which the administrator would like to investigate or focus on. Thereby, the data filter 4 is capable of extracting data from the raw dataset, which is relevant with respect to the business intelligence information, which the administrator wishes to obtain. Accordingly, applying the data filter 4 to the raw dataset stored in the raw dataset database 7 results in a subset of data, and the data contained in the subset of data is relevant with respect to the business intelligence information which the administrator wishes to obtain.

The subset of data is supplied to the analyzer 5, and the analyzer 5 performs business intelligence analysis on the data of the subset of data. Thus, the business intelligence analysis is only performed on a subset of the raw dataset, rather than on the entire raw dataset. Accordingly, the amount of data being analysed is greatly reduced, and the requirement for computing power for performing the analysis is thereby reduced. However, the data which is actually relevant with respect to the analysis being performed is included in the analysis. Thereby the analysis result must be expected to be accurate.

Several data filters 4 and analyzers 5 may be available, and may be combined in any appropriate manner in order to receive a desired analysis result.

The result of the business intelligence analysis is stored in the reduced dataset database 8 in the form of a transformed and reduced dataset. Furthermore, the result of the business intelligence analysis is supplied to the report generator 6, via the reduced dataset database 8. The report generator 6 generates a business intelligence report, based on the business intelligence analysis, and forwards the generated report to the administrator device 9, in order to make the report available to the administrator. The generated report may further be stored in the reduced dataset database 8.

The generated report may further be supplied to an analyst, via an analyst device 12. Contrary to the administrator, the analyst is not able to define the data filter 4, i.e. the analyst is not able to influence details regarding the analysis being performed. The analyst is only allowed to extract the result of the analysis in the form of the generated business intelligence report.

The business intelligence report may, e.g., include one or more graphical presentations of the result of the business intelligence analysis. Such graphical presentations may, e.g., include one or more graphs and/or one or more charts, e.g. in the form of pie charts or bar charts.

Furthermore, collected behavioural data may be supplied directly from the data collector 3 to the data filter 4. Thereby the data filter 4 is applied to the behavioural data, as it is collected.

In the case that the collected behavioural data match the criteria of the data filter 4, the collected behavioural data is included in the subset of data, and the collected behavioural data is thereby included in the data being analysed by the analyzer 5. This may, e.g., be used for updating a previously performed business intelligence analysis and/or a previously generated business intelligence report.

The collected behavioural data may, e.g., be supplied to the data filter 4 via the raw dataset database 7 in the following manner. When the data collector 3 has collected the behavioural data, it supplies the collected data to the raw dataset database 7. The data filter 4, or a component associated with the data filter 4, monitors the raw dataset database 7, and when it is detected that new behavioural data has been added to the raw dataset database 7, the new behavioural data is supplied to the data filter 4. As an alternative, the collected behavioural data may be supplied directly to the data filter 4 by the data collector 3.

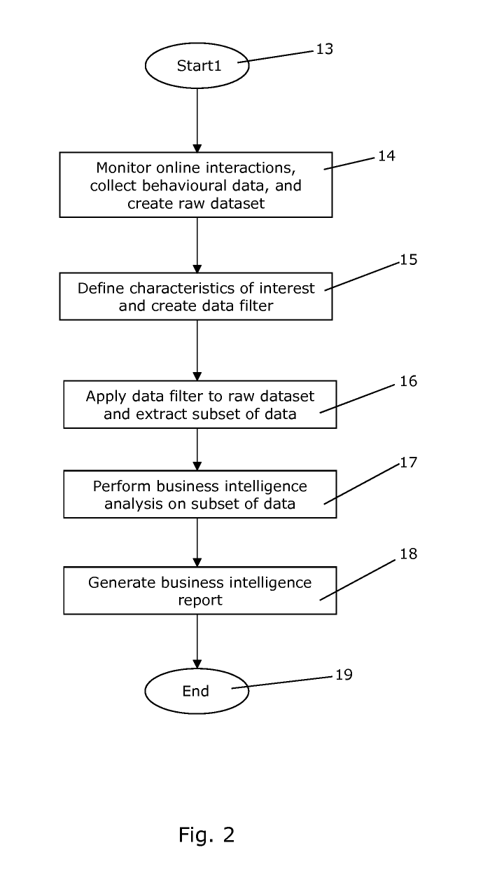

FIG. 2 is a flow chart illustrating a method according to a first embodiment of the invention. The method may, e.g., be performed using the system 1 illustrated in FIG. 1.

The process is started at step 13. At step 14 online interactions are monitored, as described above, while behavioural data relating to the online interactions is collected. Thereby a raw dataset is created, and the raw dataset is stored.

At step 15 one or more characteristics of interest of the behavioural data of the raw dataset are defined. The characteristics of interest reflect aspects of business intelligence, which it is desired to investigate. A data filter is created, based on the characteristics of interest. Thus, the data filter is capable of identifying and/or extracting data which is relevant with respect to the defined characteristics of interest, and which is thereby relevant with respect to the aspects of business intelligence which it is desired to investigate.

At step 16 the created data filter is applied to the raw dataset. Thereby a subset of data is extracted from the raw dataset, and the data of the subset of data is relevant with respect to the defined characteristics of interest.

At step 17 business intelligence analysis is performed on the subset of data. Thus, the business intelligence analysis is only performed on a part of the collected behavioural data, thereby reducing the requirement for computing power for performing the analysis. On the other hand, since the business intelligence analysis is performed on data extracted by means of the data filter, it is ensured that the data which is actually relevant with respect to the aspects of business intelligence, which it is desired to investigate, is used for the analysis.

At step 18 a business intelligence report is generated, based on the business intelligence analysis. The business intelligence report may be presented to an administrator or the like. Finally, the process is ended at step 19.

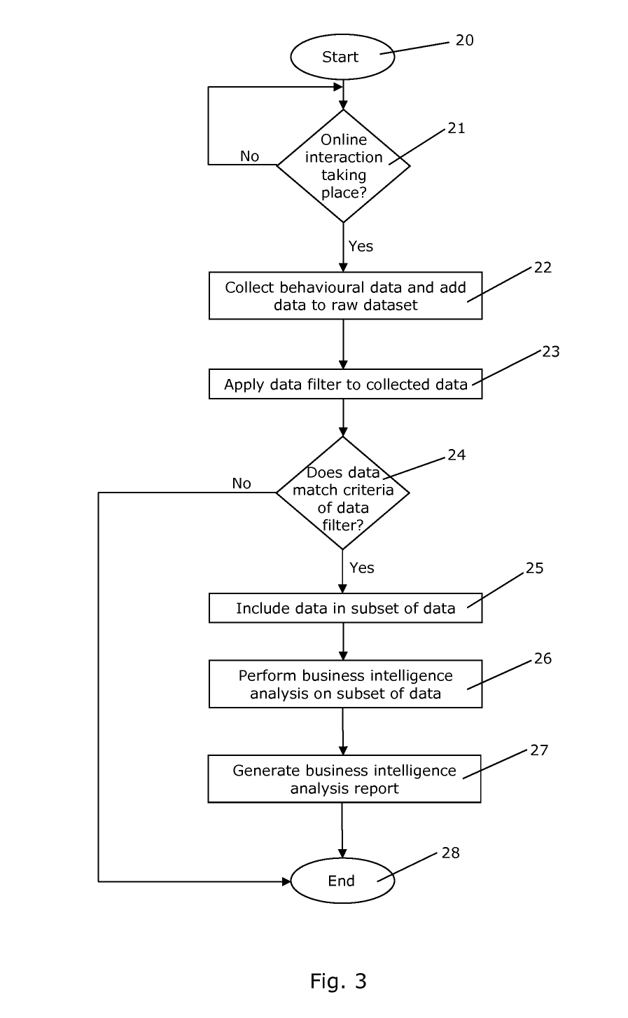

FIG. 3 is a flow chart illustrating a method according to a second embodiment of the invention. The method illustrated in FIG. 3 may, e.g., be performed in combination with the method illustrated in FIG. 2.

The process is started at step 20. At step 21 it is investigated whether or not an online interaction is taking place. If this is not the case, the process is returned to step 21 for continued monitoring for online interactions.

In the case that step 21 reveals that an online interaction is taking place, the process is forwarded to step 22, where the online interaction is monitored, and behavioural data relating to the online interaction is collected. The collected behavioural data is added to a raw dataset.

At step 23 a data filter is applied to the collected behavioural data. The data filter has previously been created on the basis of one or more defined characteristics of interest of the behavioural data, e.g. in the manner described above.

At step 24 it is investigated whether or not the collected behavioural data matches the criteria defined by the data filter. If this is the case, the process is forwarded to step 25, where the collected behavioural data is included in a subset of data. The subset of data may have been created previously, e.g. in the manner described above with reference to FIG. 2. Alternatively or additionally, the subset of data may include data originating from previous online interactions, and which has been included in the subset of data in the manner described here. In any event, the subset of data comprises data which matches the criteria defined by the data filter, and which is therefore relevant with respect to the defined characteristics of interest.

At step 26 business intelligence analysis is performed on the subset of data, i.e. the business intelligence analysis is performed on a limited amount of data, the data being relevant with respect to the defined characteristics of interest.

Finally, a business intelligence report is generated, at step 27, on the basis of the performed business intelligence analysis, before the process is ended at step 28.

After step 27, and before the process is ended at step 28, it may be investigated whether or not there are further filters to be applied. If this is the case, the process is returned to step 24.

In the case that step 24 reveals that the collected behavioural data does not match the criteria defined by the data filter, then the process is forwarded directly to step 28 and ended. Thus, in this case the collected behavioural data is merely added to the raw dataset, but it is not included in the subset of data, and does therefore not form part of the data on which the business intelligence analysis is performed.

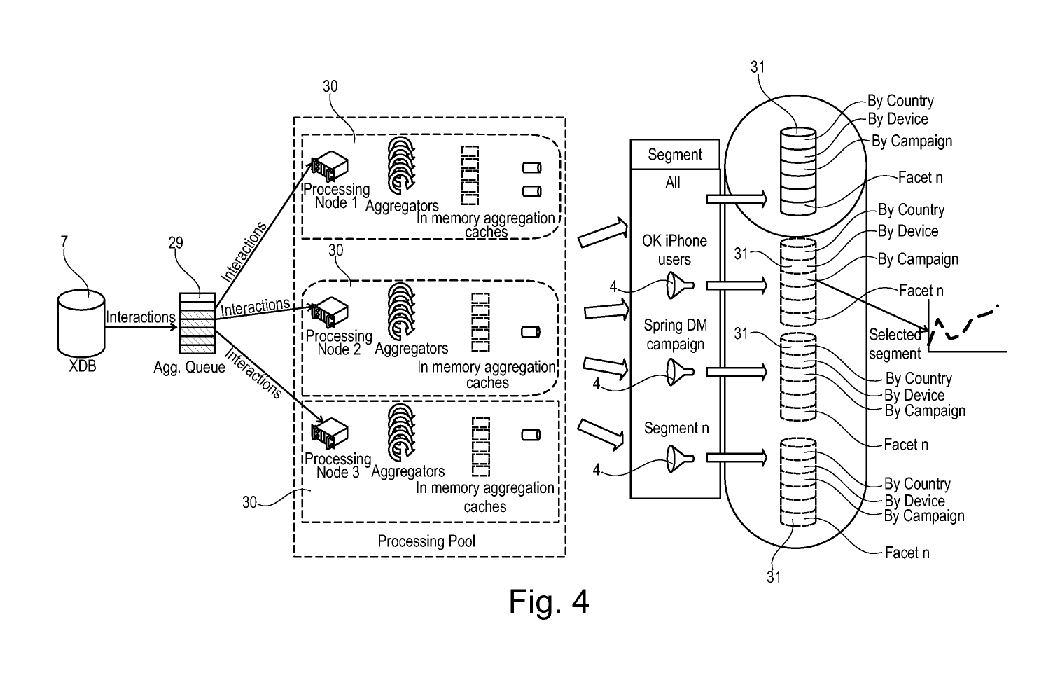

FIG. 4 is a schematic overview illustrating a method according to an embodiment of the invention.

Behavioural data relating to online interactions, which has been collected, e.g. in the manner described above, is stored in a raw dataset database 7. As the behavioural data is added to the raw dataset database 7, it is supplied to an aggregation queue 29, which ensures that the collected data is processed in an appropriate order, e.g. the order in which the data was collected.

The aggregation queue 29 distributes the collected behavioural data among a number of processing devices 30 of a processing pool, where aggregation pipelines process the data in a concurrent manner, and in memory aggregation caches are formed. At regular intervals, an in memory aggregation cache is replaced by a new empty cache. The collected data is flushed to an SQL server, and the cache is dereferenced. The data is flushed to a temporary table and merged from there into a “data series” table. This additional step increases performance by minimising the time concurrent processes write to the “data series” table.

A number of data filters 4 are then applied to the behavioural data, resulting in a number of subsets of data 31, each subset of data 31 containing behavioural data which has been identified as relevant by one of the data filters 4.

Finally, a business intelligence report is generated by performing analysis on the data of one of the subsets of data 31.

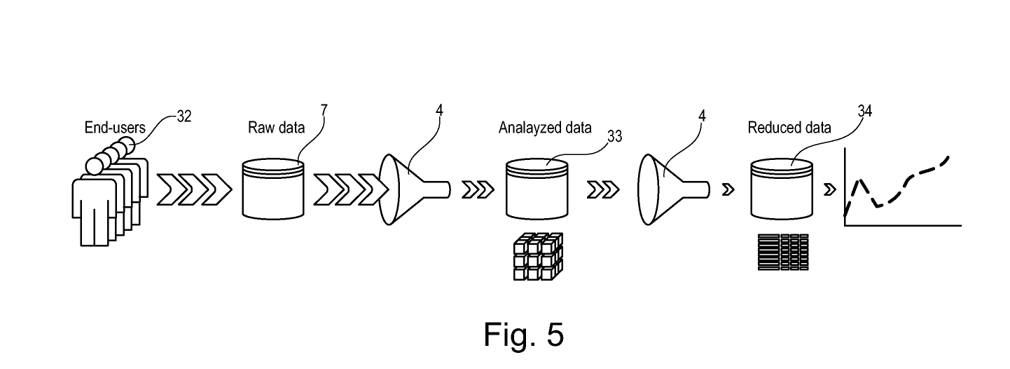

FIG. 5 is a schematic view illustrating a method according to an alternative embodiment of the invention.

Behavioural data is collected from end users 32 performing online interactions. The collected behavioural data is stored in a raw dataset database 7. A data filter 4 is applied to the data of the raw dataset, resulting in aggregated data 33. Yet another data filter 4 is then applied to the aggregated data 33, resulting in an analysed dataset 34. Finally a business intelligence report is generated on the basis of the analysed dataset 34.

It should be noted that the aggregated data 33 may not necessarily be stored in a database.

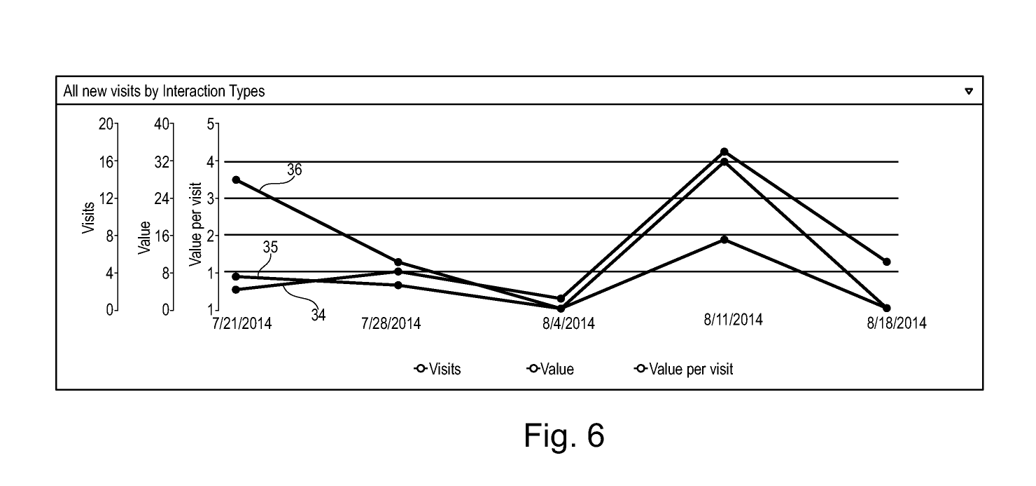

FIG. 6 is a graphical representation of a business intelligence report generated by means of a method according to an embodiment of the invention. Visits to a website were monitored, and for each visit a value point score was obtained in accordance with navigations and actions performed by the visitor, content viewed, etc., and in accordance with value points associated with the content of the website.

The collected data was filtered and analysed, and on the basis of the analysis, a business intelligence report in the form of three graphs were generated. A first graph 34 shows the number of visits as a function of time. A second graph 35 shows the total value point score as a function of time, the total value point score being the sum of the value point scores obtained by visitors visiting the website at a given date. A third graph 36 shows the value point score per visit, i.e. the total value point score, shown in the second graph 35, divided by the number of visitors, shown in the first graph 34.

A high value per visit 36 is desirable, because it indicates that a high value is generated for the website owner each time a visitor visits the website. Accordingly, high value is generated at a minimum effort. It can be seen from the graph that on 21 Jul. 2014 a very high value per visit 36 was obtained, even though the number of visits 34 as well as the total value point score 35 were relatively low on that date. Thus, the website owner may be satisfied with the result on that date, and he or she may want to investigate what made the visitors of the website on that specific date behave in such a desired manner.

Similarly, on 11 Aug. 2014 a high total value point score 35 as well as a high number of visitors 34 was obtained. This may in itself seem like a good result. However, the value per visit 36 on that date was not particularly high, indicating that an even higher total value point score 35 could be obtained, if each visitor was encouraged to exhibit a more value generating behaviour.

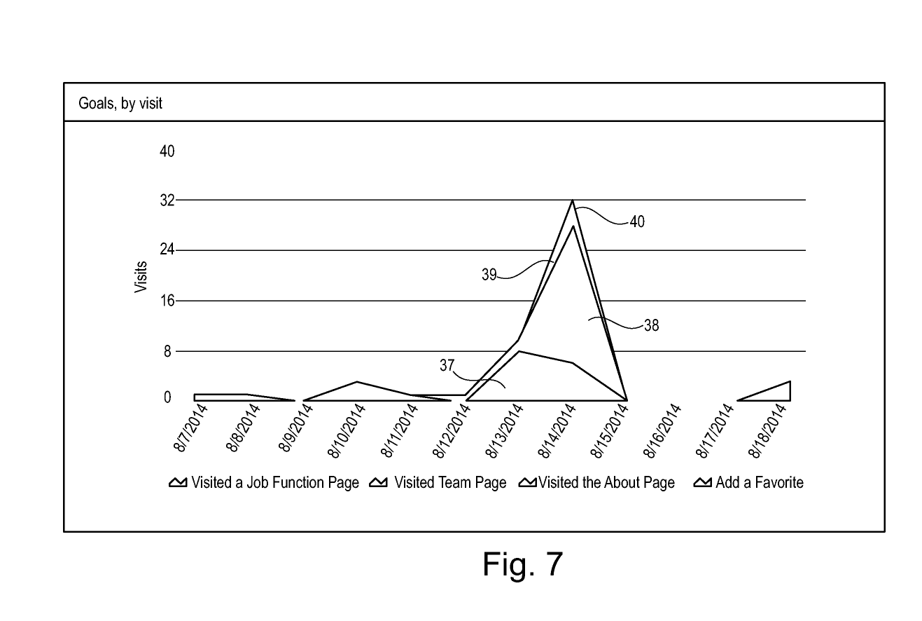

FIG. 7 is an alternative graphical representation of a business intelligence report generated by means of a method according to an embodiment of the invention. As described above with reference to FIG. 6, visits to a website were monitored, and for each visit a value point score was obtained in accordance with navigations and actions performed by the visitor, content viewed, etc., and in accordance with value points associated with the content of the website.

The collected data was filtered and analysed, and on the basis of the analysis, a business intelligence report in the form of an area chart was generated. The areas between the curves show the number of visitors visiting various webpages of the website, or performed various actions on the website, as a function of time. A first area 37 represents the number of visitors who visited a Job Function Page. A second area 38 represents the number of visitors who visited a Team Page. A third area 39 represents the number of visitors who visited an About Page. A fourth area 40 represents the number of visitors who added a Favorite.

It can be seen from the area chart that a high number of visitors visited the website on 14 Aug. 2014. Furthermore, a large portion of these visitors visited the Team Page 38, and a smaller, but still significant, portion of the visitors visited the Job Function Page 37 on this date, and on the previous date.

The Job Function Page 37, the Team Page 38, the About Page 39 and Adding a Favorite 40 may have been selected by an administrator or an analyst as business goals, in the sense that visiting one of the pages or adding a favorite constitute desired behaviour of the visitors visiting the website. Accordingly, the administrator or analyst wishes to investigate to which extend these four business goals are fulfilled by the visitors. It is clear from the area chart that the business goals regarding visiting the About Page 39 and Adding a Favorite 40 are only fulfilled by a limited number of visitors, and accordingly measures may be taken in order to encourage a larger number of visitors to fulfil these business goals.

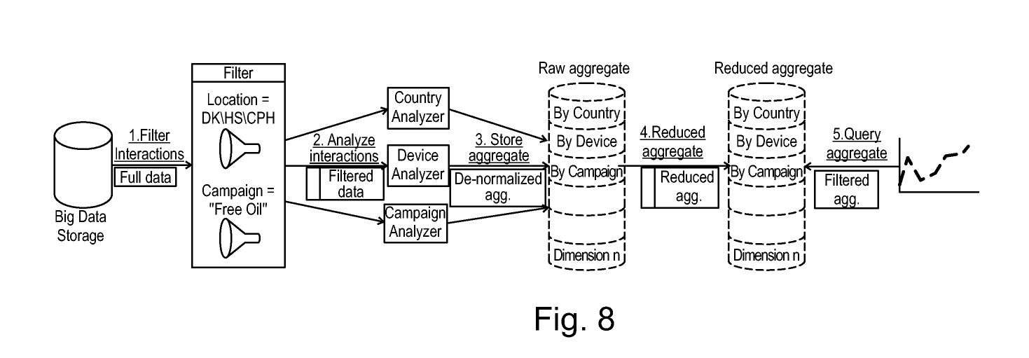

FIG. 8 is a schematic overview illustrating a method according to another alternative embodiment of the invention. In the embodiment illustrated in FIG. 8 the following steps are performed.

1. Filter Interactions

When an Interaction is processed by the system, initially the full dataset including all recorded information about the Contact and Interaction is filtered through a combination of rule criteria, defined by the user. The purpose of this selection is to focus on a subset of interactions and contacts to provide a more focused analysis. A rule criterion can examine all the recorded information about a contact and interaction, and potentially reach out to external data sources to increase the available data about a specific contact and interaction.

In the following program code rule criteria are composed in named binary tree structures to allow the end-user to build arbitrarily complex filters. In the program code example below a rule criterion is defined which includes all interactions originating from a specified location.

```
ValidateCriterion(interaction, rule)
{
  if (interaction.Location == rule.Location)
    return true;
  return false;
}
```

In the program code example below a rule criterion is defined which includes all interactions by contacts known to an external CRM system, and from a specified customer group.

```
ValidateCriterion(interaction, rule)
  {
    crmRecord =
ExternalCrm.LoadCustomer(interaction.Contact.email);
    if (crmRecord == null)
      return false;
    if (crmRecord.CustomerGroup == rule.CustomerGroup)
      return true;
    return false;
  }
```

In the program code example below CRM data was stamped on the interaction data when the interaction was collected, a rule criterion is defined which includes all interactions by contacts from a specified customer group.

```
ValidateCriterion(interaction, rule)
  {
    crmRecord = interaction.Crm.Customer.Group;
    if (crmRecord == null)
      return false;
    if (crmRecord.CustomerGroup == rule.CustomerGroup)
      return true;
    return false;
  }
```

Rule criteria are composed in expression trees to allow the end-user to build arbitrarily complex filters, which in turn enable reports to focus on a very detailed segment of interactions.
Include all interactions
   where location is Canada
      except where location is Ontario
   where CRM customer group is Premium Customers
   . . .

2. Analyze Interactions

Each filter is coupled to one or more dimensions of interest. A dimension provides a pre-defined analysis, extracting a subset of data from the full interaction record and grouping it according to some logic. An example dimension “Device types” would examine each interaction, and update a set of metrics per device type, yielding a list of facts about interactions from various device types.

In the program code example below, all interactions that are included by the filter expression are grouped by Device, and the metrics for each Device is updated to include the contribution from each interaction. The object “dimension” is of the type “Device”.

```
AnalyzeDimension(dimension, filter, interactions)
{
  filteredInteractions = filter.ApplyToAll(interactions);
  result = new AnalyzedView(filter.Name);
  foreach(interaction in filteredInteractions)
  {
    result[interaction.Date, interaction.Device] =
      dimension.Analyze(interaction)
  }
  return result.DataTable;
}
```

The result is a high-level view of the raw data, as illustrated in the example table below, showing a result from an analysis performed by the Device Dimension applying the filter “Free oil—DK”.

| | | | | | | Conver- | Total | Page |
|---|---|---|---|---|---|---|---|---|
| Filter | Date | Device | Visits | Value | Bounces | sions | Duration | Views |
| Free | 1 | Tablet | 120 | 117 | 50 | 5 | 1055 | 65 |
| oil - | May | | | | | | | |
| DK | 2015 | | | | | | | |
| Free | 1 | Mobile | 1510 | 4023 | 373 | 157 | 17030 | 501 |
| oil - | May | | | | | | | |
| DK | 2015 | | | | | | | |
| Free | 1 | Desktop | 2301 | 14021 | 971 | 601 | 30310 | 1124 |
| oil - | May | | | | | | | |
| DK | 2015 | | | | | | | |

This table essentially illustrates how the data might be stored in a database or other storage mechanism. Thereby being reduced to its final format.

The system ensures a high roll-up factor by varying its data by a limited number of fields. Each dimension is required to always group its data by:
a) Filter
b) Time slice
c) Dimension field. In this case, “Device Dimension” is the additional dimension.

Different dimensions each supply different perspectives on the data, related to each other only by their slice of time, and the applied filter. A user looking at the result of the table above may want to see more details about the location of visitors in the “Free oil—DK” group from 1 May 2015 that visited from a Mobile device. This can be achieved by creating a new filter “Free oil—DK from Mobile” which would only include the 1510 visits from Mobile, and analyze that with e.g. the City Dimension, providing further breakdown of the data as needed.

In the program code example below, all interactions that are included by the filter expression are grouped by City, and the metrics for each City is updated to include the contribution from each interaction. The filter includes only visits from Mobile that are present in the “Free oil—DK” filter. The object “Dimension” is of the type “City”.

```
filteredInteractions = filter.ApplyToAll(interactions);
    result = new AnalyzedView(filter.Name);
    foreach(interaction in filteredInteractions)
    {
      result[interaction.Date, interaction.City] =
        dimension.Analyze(interaction)
    }
    return result.DataTable;
  }
```

The result is a more detailed view of the 1510 interactions from Mobile that were present in the second row of the table above. The table below shows the result from the analysis performed by the City Dimension applying the filter “Free oil—DK from Mobile”.

| Filter | Date | City | Visits | Value | Bounces | Conversions | Duration | PageViews |
|---|---|---|---|---|---|---|---|---|
| Free . . . | 1 May | Copenhagen | 784 | 2089 | 194 | 82 | 8842 | 2091 |
| Mobile | 2015 | | | | | | | |
| Free . . . | 1 May | Aarhus | 370 | 986 | 91 | 38 | 4173 | 987 |
| Mobile | 2015 | | | | | | | |
| Free . . . | 1 May | Roskilde | 356 | 948 | 88 | 37 | 4015 | 949 |
| Mobile | 2015 | | | | | | | |

3. Store Aggregate

The aggregated results generated from analyzing interactions using dimensions can be stored as a materialized view. Since all the dimensions are required to group their results in the same way, all the dimensions that calculate the same metrics can store their results in a single shared data structure, eliminating the need to maintain several schema types, and greatly reducing complexity in querying and storing data.

The program code example below provides processing and storing of segments. StorageProvider is storing all results in one shared structure, since all results have the same shape.

```
ProcessAllSegments(segments, interactions)
  {
    foreach(segment in segments)
    {
      dimension = segment.dimension;
      filter = segment.filter;
      result = AnalyzeDimension(dimension, filter,
interactions)
      StorageProvider.Store(result);
    }
}
```

The table below shows the result of processing and storing two segments, “Free oil—DK by Device” and “All visits by Country”, where six metrics were calculated for a single date.

| Segment | | Dimension | | | | | Total | |
|---|---|---|---|---|---|---|---|---|
| Id | Date | Key | Visits | Value | Bounces | Conversions | Duration | PageViews |
| 1 | 1 May | Tablet | 120 | 117 | 50 | 5 | 1055 | 65 |
| | 2015 | | | | | | | |
| 1 | 1 May | Mobile | 1510 | 4023 | 373 | 157 | 17030 | 501 |
| | 2015 | | | | | | | |
| 1 | 1 May | Desktop | 2301 | 14021 | 971 | 601 | 30310 | 1124 |
| | 2015 | | | | | | | |
| 2 | 1 May | Denmark | 240 | 234 | 100 | 10 | 2110 | 130 |
| | 2015 | | | | | | | |
| 2 | 1 May | United | 3020 | 8046 | 746 | 314 | 34060 | 1002 |
| | 2015 | Kingdom | | | | | | |
| 2 | 1 May | United | 4602 | 28042 | 1942 | 1202 | 60620 | 2248 |
| | 2015 | States | | | | | | |

The table below show that shared metadata around a materialized view can be extracted into a separate structure.

| SegmentId | Dimension | Filter |
|---|---|---|
| 1 | DeviceType | Free oil—DK |
| 2 | Country | All visits |
| 3 | Pages | All visits |

4. Reduce Aggregate or Collapse Aggregate

As some dimensions will have a lot of variance per day, it can be prohibitively expensive to keep every collected row. Especially if collecting multiple dimensions it might end up consuming resources approaching traditional BI. At regular intervals the raw aggregate is processed by a reduction job, which selects statistically insignificant rows and collapses them into a single record recording the exact metrics for the statistical outliers, to ensure the correctness of the full dataset.

The table below illustrates an example of a situation where records can be collapsed to conserve storage space. A segment has collected 1002 records for a single date. The distribution of visits on pages has been observed to adhere to a normal distribution, where the least significant pages will represent only a small fraction of the total.

| Page | Date | Visits |
|---|---|---|
| Page 1 | May 1, 2015 | 500K |
| Page 2 | May 1, 2015 | 400K |
| Page 3 | May 1, 2015 | 300K |
| . . . | May 1, 2015 | . . . |
| Page 1000 | May 1, 2015 | 5 |
| Page 1001 | May 1, 2015 | 4 |
| Page 1002 | May 1, 2015 | 2 |

If the system is configured to keep only the 1000 most important rows per day, the data is reduced to 1001 rows, which for large volumes of data will greatly reduce required storage, at a very limited loss of fidelity. Additionally, any loss of fidelity of interest, e.g. top cities in Denmark. Can still be retrieved by then applying a filter for Danish cities and thus getting the top 1,000 cities in Denmark.

The table below illustrates an example of the results of a collapse operation on the table above, where the top 1000 records are unchanged, but the remaining records are collapsed into a single summarized row.

| Page | Date | Visits |
|---|---|---|
| Page 1 | May 1, 2015 | 500K |
| Page 2 | May 1, 2015 | 400K |
| Page 3 | May 1, 2015 | 300K |
| . . . | May 1, 2015 | |
| Page 1000 | May 1, 2015 | 5 |
| [Other Pages] | May 1, 2015 | 6 |

5. Query Aggregate

Since the result of the filter-analyze-store-collapse process is reduced to a simple flat structure, it is trivial to query it for data. In order to show a visualization of data over time in a line chart, very little additional processing is required to obtain the needed data.

The program code example below provides basic query filtering on segment and data.

```
QuerySegment(segment, fromDate, toDate)
  {
    segmentsTable StorageProvider.Read(segment);
    resultTable = new DataTable( );
    foreach(row in segmentsTable)
    {
      If(toDate > row.Date > fromDate)
        resultTable.Add(row);
    }
    return resultTable;
  }
```

Some additional processing may be required to show e.g. monthly totals, but the effort is significantly reduced compared to querying the raw data set or a traditional snowflake schema.

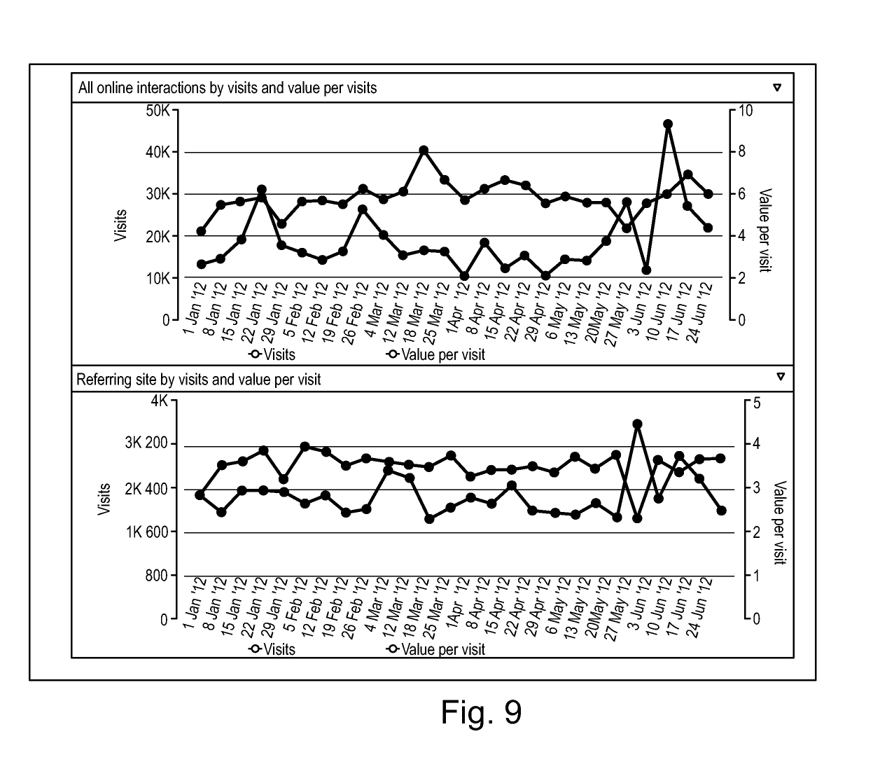

FIG. 9 is an alternative graphical representation of a business intelligence report containing two different business intelligence analyses generated by means of a method according to an embodiment of the invention. As described above with reference to FIG. 6, visits to a website were monitored, and for each visit a value point score was obtained in accordance with navigations and actions performed by the visitor, content viewed, etc., and in accordance with value points associated with the content of the website.

The two graphs in the business intelligence report of FIG. 9 are based on two different business analyses.

The upper graph, denoted “All online interactions by visits and value per visits”, illustrates a business analysis of all visits to a given website. The graph shows the number of visits as well as the value per visit, as a function of time.

The lower graph, denoted “Referring site by visits and value per visit”, illustrates the usage of a data filter by only including data referred from a specific website. This graph also shows the number of visits as well as the value per visit, as a function of time.

The two graphs in combination provide an opportunity to compare two different business analyses of the same defined characteristics of interest. In particular, comparing the upper graph and the lower graph, it can be investigated how the referrals from the specific website perform as compared to all visits to the website.

1. A method for obtaining business intelligence information relating to online interactions, the method comprising the steps of:
collecting, by means of a computer device, behavioural data relating to online interactions, originating from a plurality of online interactions, and storing the collected behavioural data in the form of a raw dataset,
defining one or more characteristics of interest of the behavioural data,
creating a data filter, based on the defined characteristics of interest, said data filter defining information of the collected behavioural data being relevant with respect to the defined characteristics of interest,
applying the data filter to the raw dataset, thereby obtaining a subset of the data of the raw dataset, said subset containing behavioural data being relevant with respect to the defined characteristics of interest,
performing business intelligence analysis on the data of the subset of data, and
generating a business intelligence report based on the business intelligence analysis, and in accordance with the defined characteristics of interest.

2. A method according to claim 1, further comprising the step of storing the result of the business intelligence analysis in the form of a transformed and reduced dataset, separate from the raw dataset.

3. A method according to claim 1, wherein the step of defining one or more characteristics of interest comprises defining information to be presented in the business intelligence report.

4. A method according to claim 1, wherein the step of defining one or more characteristics of interest comprises defining one or more graphs to be presented in the business intelligence report.

5. A method according to claim 1, wherein the step of creating a data filter comprises creating a data filter which selects a subgroup of online interactions, and wherein the step of applying the data filter to the raw dataset comprises including at least part of the collected data originating from the online interactions of the subgroup of online interactions in the subset of data.

6. A method according to claim 1, wherein the step of creating a data filter comprises creating a data filter which defines types of data collected during the online interactions, and wherein the step of applying the data filter to the raw dataset comprises including at least part the collected data originating from online interactions comprising the defined types of data in the subset of data.

7. A method according to claim 1, wherein the step of creating a data filter comprises creating a data filter which defines specific criteria for data collected during the online interactions, and wherein the step or applying the data filter to the raw dataset comprises including at least part of the collected data originating from online interactions comprising data fulfilling the specific criteria in the subset of data.

8. A method according to claim 1, wherein the step of generating a business intelligence report comprises generating one or more graphs, and displaying the graph(s).

9. A method according to claim 1, further comprising the steps of:
allowing an additional online interaction to take place,
collecting, by means of a computer device, behavioural data relating to the additional online interaction, and including the collected behavioural data in the raw dataset,
during the step of collecting behavioural data, applying the data filter to the behavioural data being collected, and
including at least part of the collected behavioural data in the subset of data to the extent that the collected data fulfils criteria defined by the data filter.

10. A method according to claim 1, further comprising the steps of:
defining one or more new characteristics of interest of the behavioural data,
creating a new data filter, based on the new defined characteristics of interest, said new data filter defining information of the collected behavioural data being relevant with respect to the new defined characteristics of interest,
applying the new data filter to the raw dataset, thereby obtaining a new subset of the data of the raw dataset, said new subset containing behavioural data being relevant with respect to the new defined characteristics of interest,
performing business intelligence analysis on the data of the new subset of data, and
generating a business intelligence report based on the business intelligence analysis, and in accordance with the new defined characteristics of interest.

11. A method according to claim 1, further comprising the steps of:
defining one or more additional characteristics of interest of the behavioural data,
adjusting the data filter, based on the additional characteristics of interest, said adjusted data filter defining information of the collected behavioural data being relevant with respect to the additional characteristics of interest,
applying the adjusted data filter to the subset of the data of the raw dataset, thereby obtaining a reduced subset of data, said reduced subset containing behavioural data being relevant with respect to the additional characteristics of interest,
performing business intelligence analysis on the data of the reduced subset of data, and
generating a business intelligence report based on the business intelligence analysis, and further in accordance with the additional characteristics of interest.

12. A method according to claim 1, wherein the online interactions comprise one or more interactions selected from the group consisting of: visit to a website, visit to social media, visit to mobile app, receipt of an e-mail, sending of an e-mail, filling in a form, and response to an online advertisement.

13. A method according to claim 1, further comprising the step of including offline data to the raw dataset.

14. A method according to claim 1, further comprising the step of importing behavioural data from one or more external data sources, said external data sources containing behavioural data relating to one or more individuals performing online interactions.

15. A method according to claim 1, further comprising the step of aggregating the data of the subset of data further.
